(19) United States
(12) Patent Application Publication
(10) Pub. No.: US 2005/0276567 A1
(43) Pub. Date: Dec. 15, 2005

(54) Recording equipment and recording method

(75) Inventors: Kobutaka Okuyama, Yokohama (JP); Kenji Katsumata, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/439,614

(22) Filed: May 15, 2003

(30) Foreign Application Priority Data
Dec. 2, 2002 (JP) 2002-349356

(51) Int. Cl. H04N 5/76; H04N 5/781

(52) U.S. Cl. 386/46; 386/125

(57) ABSTRACT

If programs are always recorded according to a decision that is made-based on the user preferences survey results or specific categories and user's recording instruction, the user will lose the opportunity to view programs of categories other than the user preferences. Further, if the entire viewable broadcast is recorded without any selection, a problem arises that there are required greatly increased storage capacity and greatly increased capacity of processing the bit rate required for the recording. According to the present invention, a rate converter is provided for changing a bit rate for each channel, the history of programs that have been viewed by the user is recorded as the usage history, the usage tendency of the user is extracted from the usage history with an agent, a decision is made as to whether the program selected for each channel matches the usage tendency of the user, and in case of matching the program is recorded on the recording medium without varying a bit rate allowing the high-quality video to be maintained, whereas when the selected program does not match the usage tendency of the user, the program is recorded on the recording medium upon conversion to a lower bit rate.

### BACKGROUND OF THE INVENTION

1. Field of the Invention

The present invention relates to recording equipment for recording input information, for example, television broadcast over a long period of time.

2. Description of the Related Art

The conventional recording equipment, for example, as disclosed in Japanese Patent Application Laid-open No. 2000-261750, comprises main recording means for storing the received broadcast information based on the user's recording instructions and auxiliary recording means for information compressing and recording the broadcast that is being viewed, while the user is viewing the received broadcast information. Such an equipment automatically decides as to whether the recording should be made based on the category or user preferences.

Further, Japanese Patent Application Laid-open No. 8-180504 discloses the equipment for recording based on the decision concerning the presence of a frequently received program which is made with a channel history memory.

### SUMMARY OF THE INVENTION

If programs are always recorded according to a decision that is made based on the user preferences survey results or specific categories and user's recording instruction, the user will lose the opportunity to view programs of categories other than the user preferences. Further, if the entire viewable broadcast is recorded without any selection, a problem arises that there are required greatly increased storage capacity and greatly increased capacity of processing the bit rate required for the recording. It is an object of the present invention to enable the reproduction of a program matching the user preferences in a high-quality video.

The present invention provides a recording equipment comprising at least one tuner capable of receiving a broadcast of a plurality of channels and rate converters for changing a bit rate for each channel after separation when the output of the tuner includes a plurality of channels which have been multiplexed, wherein the history of the programs that have been viewed by the user is recorded as the usage history, the usage tendency of the user is extracted from the usage history with an agent, a decision is made as to whether the program selected for each channel matches the usage tendency of the user, and in case of matching, the recording is made on a recording medium directly at a bit rate allowing the high-quality video to be maintained, whereas when the usage tendency of the user is not matched, recording is made on the recording medium upon conversion to a low bit rate.

As described above, according to the present invention, broadcasted programs can be recorded and viewed by providing a storage medium with relatively small storage capacity.

### BRIEF DESCRIPTION OF THE DRAWINGS

These and other features, objects and advantages of the present invention will become more apparent from the following description when taken in conjunction with the accompanying drawings wherein:

FIG. 1 is a block diagram illustrating the rate converting and recording system in accordance with the present invention;

FIG. 2 illustrates an example of bit rate distribution of video data handled by the recording and reproducing control unit in accordance with the present invention;

FIG. 3 illustrates an example of bit rate distribution of video data handled by the recording and reproducing control unit in accordance with the present invention;

FIG. 4 is a block diagram illustrating the rate converting system in accordance with the present invention;

FIG. 5 illustrates rate conversion operation of the rate converter in accordance with the present invention;

FIG. 6 illustrates a bit rate of video data input and output in the rate converter in accordance with the present invention; and

FIG. 7 illustrates a program guide for reproducing a program recorded in accordance with the present invention.

### DESCRIPTION OF THE PREFERRED EMBODIMENTS

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications as fall within the scope of the appended claims.

An embodiment of the present invention will be described below.

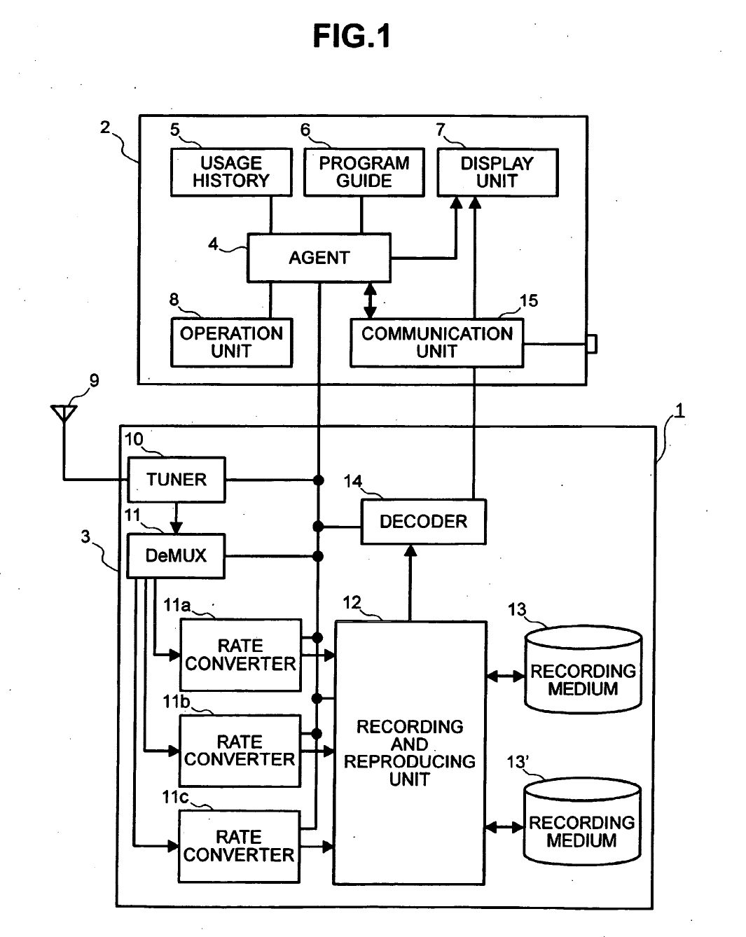

FIG. 1 is a block-diagram illustrating the configuration of the rate converting system in accordance with the present invention. A rate converting system 1 is composed of a control and display unit 2 and a recording and reproducing unit 3. Further, control and display unit 2 comprises an agent 4 for controlling the entire system, an operation unit 8 a usage history 5 for managing and holding the usage information for a user, and a program guide 6 for managing and holding the program information introduced via broadcasting or communication. The program information obtained via broadcasting or communication includes the program title, category, performer, contents, and the like.

Further, the recording and reproducing unit comprises a tuner 10, a DeMUX (demultiplexer) 11 for demultiplexing the stream of digital broadcasting of the tuner output into each program or program information, a plurality of rate converters 11a, 11b, 11c, a recording and reproducing control unit 12, a recording medium 13 and a decoder 14.

In the present embodiment, the agent 4 analyzes the usage tendency of the user based on the usage history, determines the program matching the usage tendency from the program guide, passes the program matching the usage tendency through the rate converter 11a at a high bit rate and without compressing, indicates a low-bit rate with a high compression for the program that does not match the usage tendency, converts the bit rate with rate converters 11b, 11c, and records the output thereof on recording medium 13 via recording and reproducing control unit 12. Usage history 5 is obtained by agent 4 extracting and recording the usage information (for example, category, performer, program contents, and the like) of the programs that have been used and reproduced by the user from decoder 14 or recording and reproducing control unit 12.

The program that has been recorded or is being recorded is read out from recording medium 13 into recording and reproducing control unit 12 and decoded with decoder 14, and video is thereafter displayed on display unit 7. Recording and reproducing control unit 12 thus executes recording and reproduction of a plurality of programs by multitask processing. Here, the upper limit of the bit rate handled in recording and reproducing control unit 12 may be in general no more than a total sum of bit rates of all video data handled by multitask processing.

Further, the analysis of the usage tendency of the user may be handled as a program which is simply repeated each week from the weekday and time it was used, based on the usage history. Further, a keyword of a category or performer may be extracted from the program information and the program guide may be searched by the extracted keyword. Further, the keyword can be also determined by reference to the usage history or may be set by the user. The usage history 5 can be also recorded separately by a plurality of users. It is the user who sets which of the above-mentioned information groups will have preference. For example, some users can make settings such that great importance will be attached to the history information relating to a performer. Further, the history information may be reset according to a period in which the program of TV station is changed.

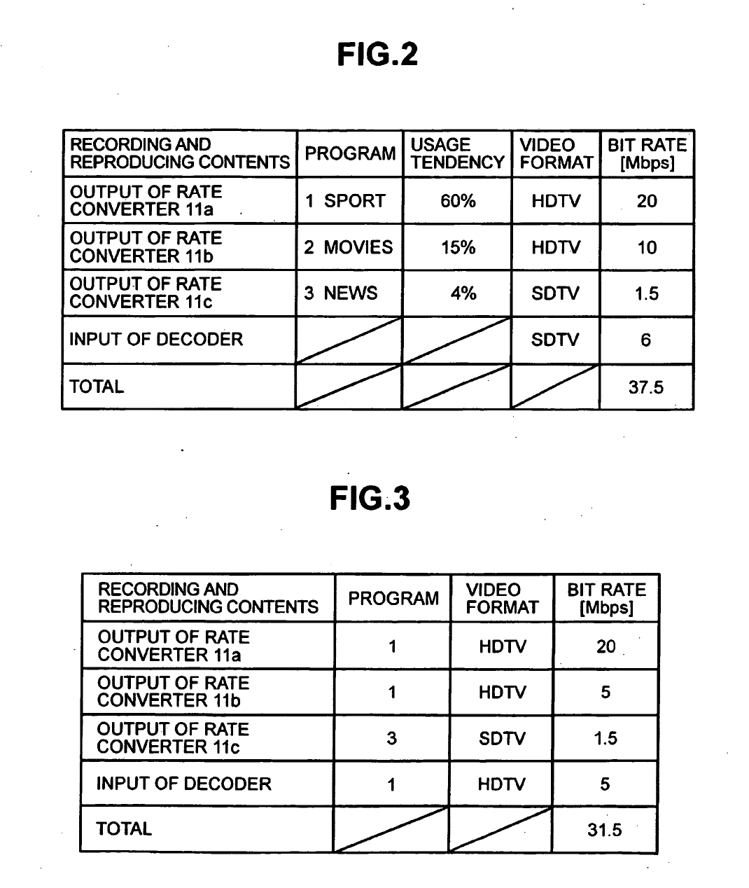

FIG. 2 illustrates an example of bit rate distribution of each video data handled by the recording and reproducing control unit. Here, agent 4 compares the data, such as keywords, and the like, recorded in the usage history 5 with the keyword contained in the program information extracted from the input program and presents the matching ratio thereof with an index. For example, because program 1 of video data from rate converter 11a is sport in a HDTV (high definition television video) format and the usage tendency of the user is high (60%), the program is output at a bit rate of 20 Mbps, without rate conversion. Program 2 of video data from rate converter 11b is movies in a HDTV format, but because the usage tendency of the user is low (15%), the program is output upon bit rate conversion from 20 Mbps to 10 Mbps. Further, program 3 of video data from rate converter 11c is news in a SDTV (standard television video) format, and because the usage tendency of the user is very low (4%), the program is output upon conversion from 6 Mbps to a low bit rate of 1.5 Mbps. Thus, when the index is no less than 40%, no rate conversion is conducted, and when the index is 10-40%, the data is compressed to about one half. When the index is no more than 10%, the compressing ratio is determined so as to compress data to a rate of about one fourth.

On the other hand, video data of SDTV format that has already been recorded at 6 Mbps is read out from the recording medium 13. Therefore, recording and reproducing control unit 12 and recording medium 13 are required to have a capacity of processing data at least at a bit rate of 37.5 Mbps.

In the present embodiment, with the usual recording without rate conversion, a total of 46 Mbps (20+20+6) data has to be recorded, whereas recording in which the preference tendency is decided upon with the agent can reduce this amount to a total of 31.5 Mbps.

When programs of a plurality of streams are received, a plurality of sets of tuners, DeMUX, and rate converters (not shown in the figures) may be provided.

Further, rate converter 11c may also conduct transcoding from MPEG2 that was digitally broadcasted to MPEG4 or other video compressing format. In this case the video data of MPEG 2 may be encoded from an intermediate stage of a decoder to another video compressing format, without 100% decoding.

Furthermore, when a plurality of programs identical in video and differing in audio, for example, languages, are broadcasted or when the same program is broadcasted several times in the same day with a shift in time, presetting the selection conditions will allow the program with the same video information to be recorded automatically only one time.

FIG. 3 illustrates another example of bit rate distribution of video data handled by the recording and reproducing control unit in accordance with the present invention, this example relating to a case when a user has instructed time shift reproduction of program 1. A set of bit rates during operation corresponding to FIG. 2 is also shown in this figure. Because video data from rate converter 11a is in a HDTV format and matches the usage tendency of the user, the data is output at a bit rate of 20 Mbps without rate conversion. Rate converter 11b outputs the program data identical to that of rate converter 11a upon rate conversion to 5 Mbps and the data is double recorded as video data for time shift reproduction. Furthermore, video data of program 3 from rate converter 11c is in SDTV format, but because it does not match the usage tendency of the user, it is output upon conversion from 6 Mbps to a low-bit rate of 1.5 Mbps. On the other hand, video data in the HDTV format which is being recorded at 5 Mbps is read out from recording medium 13 with a time shift. Therefore, recording and reproducing control unit 12 and recording medium 13 are required to have a capacity of processing data at least at a bit rate of 31.5 Mbps.

In the present embodiment, in case of usual time shift reproducing without double recording, 41.5 Mbps (20+1.5+20) data has to be recorded and reproduced whereas double recording can reduce the total bit rate of recording and reproducing to 31.5 Mbps.

A communication unit 15 and a second recording medium 13′ can be provided as additional components with respect to the configuration shown in FIG. 1. With communication unit 15, program information can be input from internet and held in the program guide. Further, information indicating that the program is a recommended program is input from internet or broadcast signals and stored in the agent. When added to the video signal, the recommended program may be assigned with a priority separately from the usage tendency of the user and rate converted to a high bit rate with rate converters 11a, 11b, 11c at a low compressing rate by separating this information and storing in the agent. In the present embodiment, two recording media 13, 13′ were provided. Thus providing a plurality of recording media makes it possible to enlarge the total of bit rates that can be recorded and reproduced simultaneously and to conduct long-time recording of a larger number of channels.

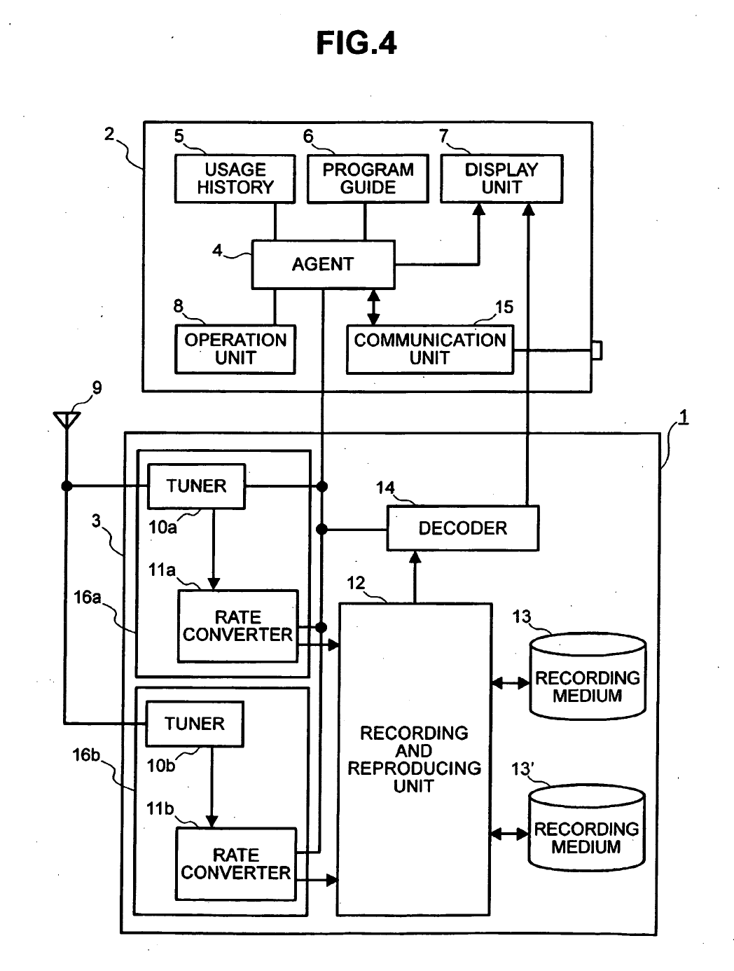

FIG. 4 is a block diagram of a rate converting system of the other embodiment of the present invention. Components operating identically to the components shown in FIG. 1 are assigned with identical reference symbols. In the present embodiment, a plurality of tuners 10a, 10b and a plurality of rate converters 11a, 11b for analog broadcasting are provided. The difference between this embodiment and the above-described embodiment is in that the DeMUX is not provided because no multiplexing was employed due to analog broadcasting and in that the rate converters are provided with a function of encoding from analog video signals.

Further, a configuration may be also employed in which receiving units 16a, 16b each containing one tuner and one rate converter can be attached and detached separately from each other. The advantage of the configuration composed of such receiving units is that the number of receiving units may be increased, if necessary, according to the number of channels that the user will receive at the same time and the configuration can be easily changed. Further, it is also possible to increase the number of such receiving units in the above-described configuration for digital broadcast and to conduct simultaneous recording of digital broadcast and analog broadcast.

Furthermore, when the number of channels that can receive analog broadcast is larger than the number of tuners, they can be selected in order of priority channels that were assigned with priority based on the user preferences and recommended program, and the channel selected by a specific tuner may be changed by changing the program as time elapses.

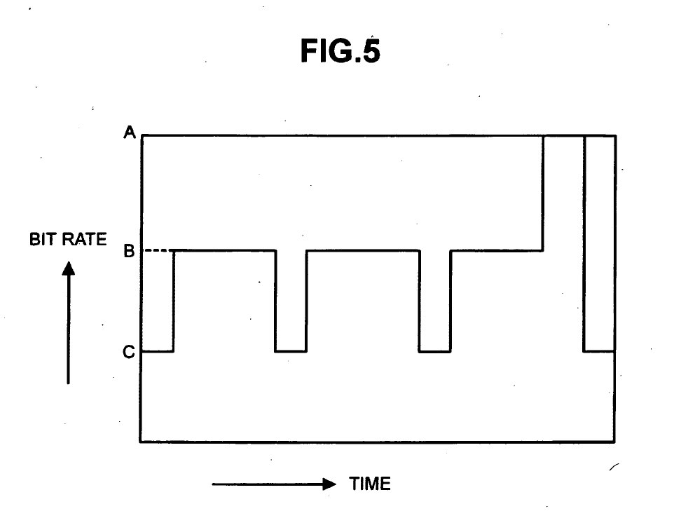

FIG. 5 is a performance chart illustrating another example of rate conversion operation of the rate converter in accordance with the present invention. This figure illustrates a bit rate after conversion with a rate converter during one program. The bit rate C with the lowermost level represents a case when broadcasting of commercials was detected, for example, by changes in the voice mode. The bit rate B of the medium level represents a case when a usual program has been broadcasted. Further, the bit rate A of the high level represents a case when broadcasting of highlights was detected by program information. With the present embodiment, highlights of major interest can be recorded as a high-quality video. For commercials, the bit rate can be decreased and the quantity of recorded data can be reduced. Thus, if recording in the same program is conducted by taking the contents into account, then the entire quantity of data can be reduced by recording only the contents with a high priority as high-quality video and recording other contents at a low bit rate.

Further, by employing the difference in the recording bit rates, it is also possible to provide a function of conducting the reproducing operation with skipping of the next commercial. during reproduction. When using the system, the user may directly supply an instruction of changing the bit rate of recording to the operation unit.

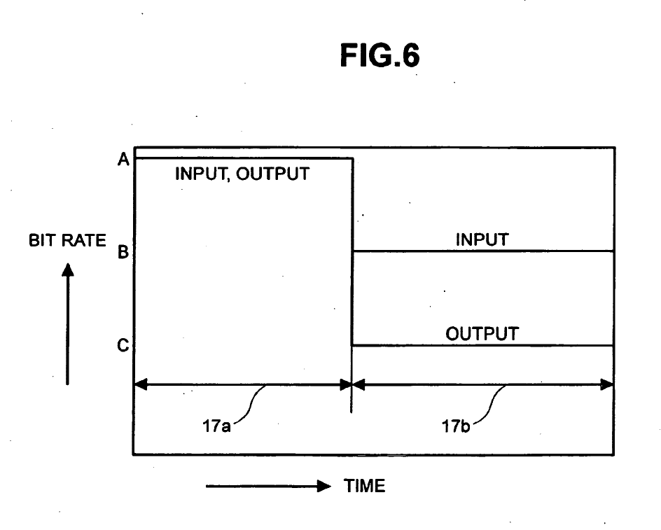

FIG. 6 is a performance chart illustrating an example of rate conversion operation of the rate converter in accordance with the present invention. In HDTV broadcasting, the original video data is sometimes SDTV, but broadcasted as HDTV. However, in this case, the bit rate of inputting into the rate converter decreases by comparison with that in the case when the original video data is in HDTV. FIG. 6 shows the bit rate of video data input in the rate converter. In a HDTV broadcast time zone 17a, the original video data is HDTV and the average level is a high bit rate A, whereas in a time zone 17b in which SDTV video is broadcasted as HDTV, because the amount of information is small, the average level is a low bit rate B and the difference therebetween can be recognized automatically. In the HDTV broadcast time zone 17a, output is conducted without changing the bit rate, and the average level is a high bit rate A. In the time zone 17b, converting to SDTV of the original video data automatically switches the average level to a bit rate with an average level C which is even lower than B.

Therefore, it is possible to detect automatically when a SDTV video is broadcasted as HDTV and to record a small amount of data, practically without quality degradation.

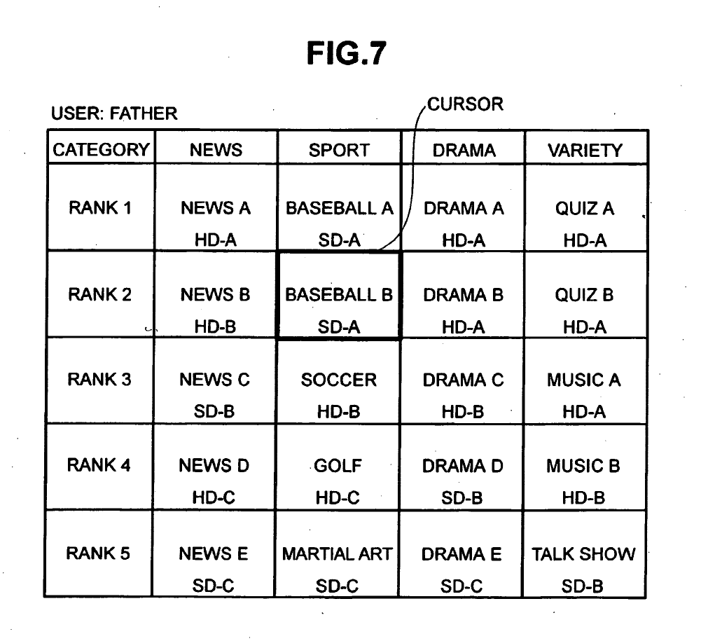

FIG. 7 shows a program guide for reproducing the program recorded in accordance with the present invention. The programs shown in the figure are separated by categories and assigned with category ranks with the usage tendency of the user. Therefore, the most appropriate program can be started merely by selecting a category according to the user's mood and usage time zone. For example, in case of news, the category rank is assigned based on the time zone and channel often viewed by the viewer, and in case of drama the category rank is assigned based on the performance of the favorite actor of the user. When the initially displayed program does not meet the user's wishes, the program with a next category rank may be displayed by an operation similar to a channel feed, or the above-mentioned program guide may be displayed for selection. For example, in case of sport, when the user who often watches baseball decided to watch martial arts according to the mood of the day, if the cursor is moved to martial arts, the martial arts program can be immediately reproduced. Furthermore, the picture quality information and compressing rate during recording are also added. Here, HDTV format and SDTV format are distinguished, and the compressing ratio is displayed as A (no compressing), B (low compressing ratio), and C (high compressing ratio).

By opening the aforesaid usage guides separately for a plurality of users makes it possible to accumulate the preference information for each user and to display usage guides for reproducing the recorded program matching the preferences of each user.

Further the broadcasting in accordance with the present invention can be assumed to include not only analog and digital broadcasting, but also data or information such as streaming via a communication circuit. In such a case, an interface adapted for networking is used instated of tuner 10.

As described above, the present invention enables program recording that can be used at user's discretion.

1. Recording equipment for recording programs containing video, comprising:
an input terminal to which programs are provided;
an information acquirer which acquires information relating to the programs that are received at the input terminal;
a rate converter which converts a bit rate of the program provided;
a recorder and reproducer which records and reproduces the program for which the bit rate has been converted;
a memory which stores the information relating to the programs that were viewed by the user, among the programs that have been provided; and
a controller which controls the bit rate in the rate converter based on the information stored in the memory and the information acquired by the information acquirer.

2. The recording equipment according to claim 1 wherein when a program is recorded, the controller increases the bit rate in the rate converter when the program and a usage tendency of the user match more closely.

3. The recording equipment according to claim 2 wherein the controller ranks programs based on the usage tendency, and a program is recorded with a higher bit rate as the programs is ranked higher.

4. The recording equipment according to claim 1 wherein when the program is a specific program, the program is recorded with the controller increasing the bit rate in the rate converter regardless of the information stored in the memory.

5. The recording equipment according to claim 1 wherein the controller detects a specific scene in the program and varies the bit rate in the rate converter based on the detected scene.

6. The recording equipment according to claim 5 wherein the specific scene is a commercial, and the controller records this scene at a lower bit rate in the rate converter.

7. The recording equipment according to claim 1 wherein:
the controller controls the recorder and reproducer so that recording of a program is conducted at a first bit rate and a second bit rate lower than the first bit rate; and
the program recorded at the second bit rate is reproduced when a special operation is conducted during reproduction of the program recorded at the first bit rate.

8. The recording equipment according to claim 1 wherein the controller increases the bit rate of a recording when the recording is of a high definition television video, and decreases the bit rate when the recording is a standard definition television video.

9. The recording equipment according to claim 1 further comprising:
a decoder which decodes a video signal reproduced by the recorder and reproducer; and
a display which displays the video signal decoded by the decoder.

10. A recording method for recording a plurality of programs comprising:
storing past usage information;
inputting a plurality of programs;
acquiring program information for the programs which are input;
comparing the acquired program information and stored usage information;
determining the compressing rate of recorded video signals based on the comparison; and
recording the video signals based on the determined compression rate.

11. The recording method according to claim 10 further comprising the steps of:
reproducing the recorded program; and
displaying the reproduced program.

12. The recording method according to claim 10 wherein the step of acquiring program information includes acquiring the program via internet.

13. Recording equipment for recording a plurality of input programs, the equipment comprising:
an input terminal which accepts input of a plurality of programs having bit rates;
a rate converter which converts the bit rate of the received program;
a recorder and reproducer which records and reproduces the program for which the bit rate has been converted by the rate converter based on a usage tendency of the user; and
a program information creator which creates a program guide of programs recorded by the recorder and reproducer based on the usage tendency of the user.

14. The recording equipment according to claim 13 wherein information relating to the bit rate of the recorded program is added to the program guide.

15. The recording equipment according to claim 14 wherein the program information creator creates a plurality of program guides based on the usage tendencies of a plurality of users respectively.
